(19) United States
(12) Patent Application Publication
(10) Pub. No.: US 2013/0066747 A1
(43) Pub. Date: Mar. 14, 2013

(54) Systems and Methods for Creating a Customer Profile, Managing a Customer Profile, Providing Customer Profile Security and Providing a Payment Service Associated with a Customer Profile

(71) Applicants: Thomas R. Bartz, Lynden, WA (US); Thomas R. Ryan, Lynden, WA (US); Philip N. McKee, Lynden, WA (US); Brent K. Droullard, Lynden, WA (US)

(72) Inventors: Thomas R. Bartz, Lynden, WA (US); Thomas R. Ryan, Lynden, WA (US); Philip N. McKee, Lynden, WA (US); Brent K. Droullard, Lynden, WA (US)

(21) Appl. No.: 13/603,271

(22) Filed: Sep. 4, 2012

Related U.S. Application Data
(63) Continuation of application No. 12/559,494, filed on Sep. 14, 2009, now abandoned.
(60) Provisional application No. 61/096,763, filed on Sep. 12, 2008.

(51) Int. Cl. G06Q 30/00

(52) U.S. Cl. 705/27.1

(57) ABSTRACT

Systems and methods for creating a customer profile, managing a customer profile, providing customer profile security and providing a payment service associated with a customer profile are provided.

### CROSS-REFERENCE TO RELATED APPLICATION

Priority is claimed from U.S. Provisional Patent Application Ser. No. 61/096,763 filed Sep. 12, 2008 and entitled “Systems and Methods for Creating a Customer Profile, Managing a Customer Profile, Providing Customer Profile Security and Providing a Payment Service Associated with a Customer Profile,” which is incorporated by reference herein in its entirety.

### TECHNICAL FIELD

The present invention relates generally to improvements in business systems and/or business methods in retail and/or service industries, including improvements in customer service and customer relations.

### BACKGROUND INFORMATION

Consumers have many choices from where to purchase products or services. Many criteria are used by consumers when deciding on a particular vendor from which to purchase a product or service. These criteria may include price, convenience, vendor reputation, level of customer personalization and vendor return policy, among other things.

Every day, vendors battle to allure consumers to their stores, regardless of whether such stores are “brick and mortar” businesses, “bricks-and-clicks” businesses or solely online shops. Furthermore, vendors compete to secure customer loyalty, manifest in the selection of the particular vendor in favor of alternatives. In order for vendors to distinguish themselves from their competitors, it is important for vendors to develop business systems and/or methods that account for the criteria used by consumers in deciding on a particular vendor from which to purchase a product or service.

Some vendors have developed customer loyalty programs where, for example, members of loyalty programs receive discounted prices or receive a free item/service (or free items/services) after a certain number of purchases. However, existing customer loyalty programs are somewhat limited.

It would be desirable to develop a robust customer loyalty program that enhances customer service and/or customer relations.

### SUMMARY OF THE INVENTION

The present invention is designed to address at least one of the aforementioned problems and/or meet at least one of the aforementioned needs.

Systems and methods for creating a customer profile, managing a customer profile, providing customer profile security and providing a payment service associated with a customer profile are disclosed.

Certain objects, features, embodiments and advantages of the invention will be apparent from the following specification taken in conjunction with the following drawings.

### BRIEF DESCRIPTION OF THE DRAWINGS

FIG. 1 is a flowchart that illustrates an exemplary customer enrollment process in accordance with embodiments of the invention;

FIGS. 2A-2H are exemplary screenshots of an exemplary customer web interface in accordance with embodiments of the present invention;

FIGS. 3A-3F are exemplary screenshots of an exemplary customer records management graphical user interface in accordance with embodiments of the present invention;

FIGS. 4A-4F are exemplary screenshots of an exemplary display at a point of sale terminal, which illustrate use of a fulfillment number to securely obtain a piece of media that is associated with a customer profile, in accordance with embodiments of the present invention;

FIGS. 5A-5F are exemplary screenshots of an exemplary display at a point of sales terminal, which illustrate how an operator assists a customer in redeeming in-store credits, in accordance with embodiments of the present invention; and,

FIG. 6 is an exemplary flowchart that illustrates exemplary processes by which a piece of media is authenticated and a user profile is returned to a point of sale terminal, in accordance with embodiments of the present invention.

### DETAILED DESCRIPTION

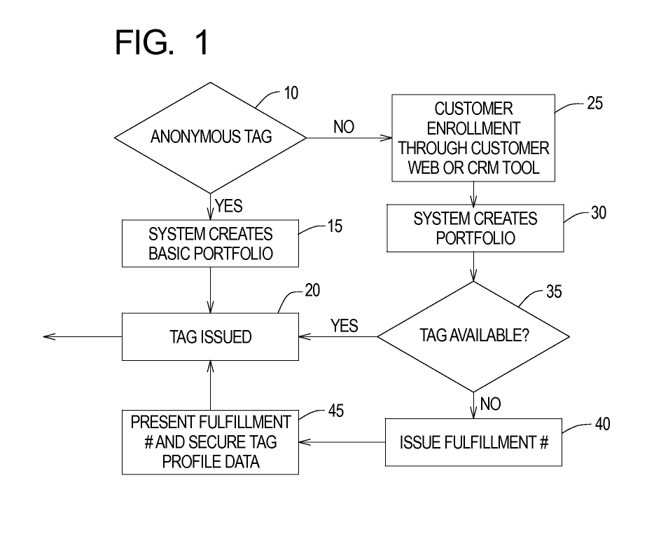

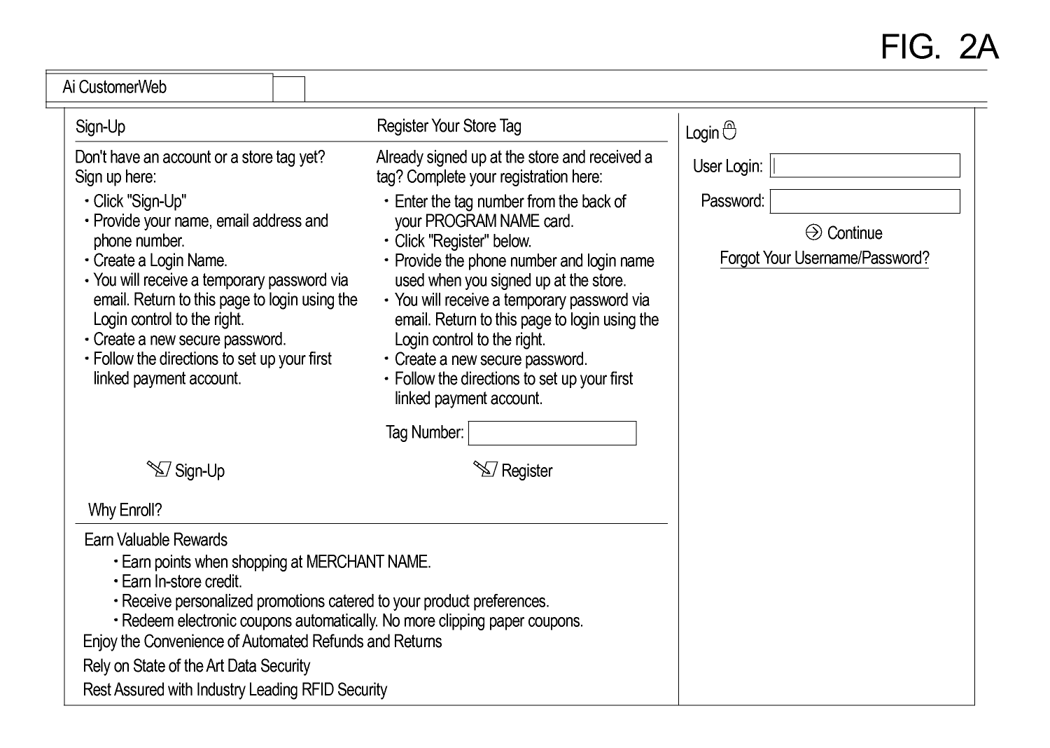

FIG. 1 illustrates a process for associating a piece of media (e.g., card with magnetic stripe, radio frequency identification (RFID) tag, etc.) with a customer profile or associating a personal identifier such as a telephone number with a customer profile. The process may be used in conjunction with a customer loyalty program, but is not necessarily limited to such circumstances. For ease of description, FIG. 1 will be referred to as illustrating an enrollment process or customer enrollment process.

After a consumer makes a decision to begin the enrollment process, the system allows the consumer to choose between enrolling anonymously 10, where only a relatively small amount of information is required, or enrolling non-anonymously. The relatively small amount of information required for anonymous enrollment can include, for example, one or more of the following: a name (not necessarily a person's name), an email address, a telephone number (e.g., a mobile telephone number), an address, a password and a password question. In one embodiment, only a user name and an email address are required. In one embodiment, only a user name and a telephone number are required. In one embodiment, only a telephone number is required.

If anonymous enrollment is selected, in one embodiment, the system creates an electronic portfolio 15 that is associated with a piece of media (or telephone number) using the information required for opening an anonymous account. Then, the piece of media is issued 20 to the customer and the customer is ready to shop and future interactions will be captured by the system and placed into a local or networked database account associated with that customer. In one embodiment, anonymous enrollment is only available to a customer that is obtaining their media at the vendor's store.

It should be understood that the “system” of the present invention is primarily a computer system, which may include several pieces of hardware and/or software that are operating in conjunction with one another. The pieces of hardware and/or the software may be located at a variety of remote physical locations although, in some embodiments, they may be located in the same building.

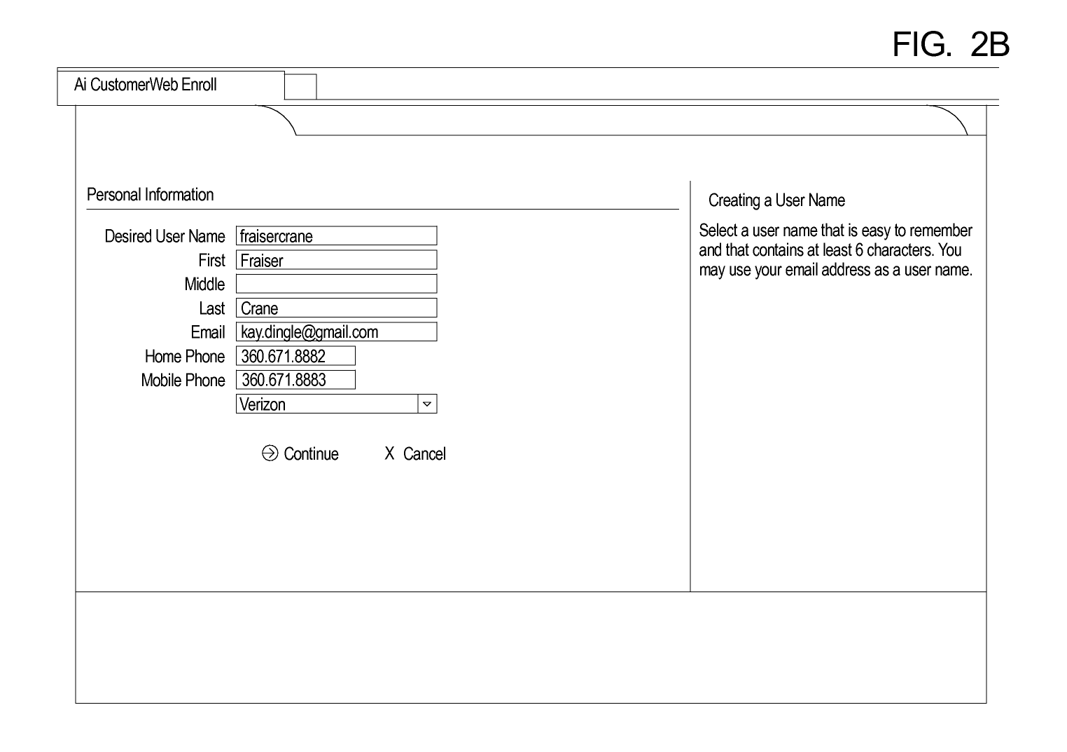

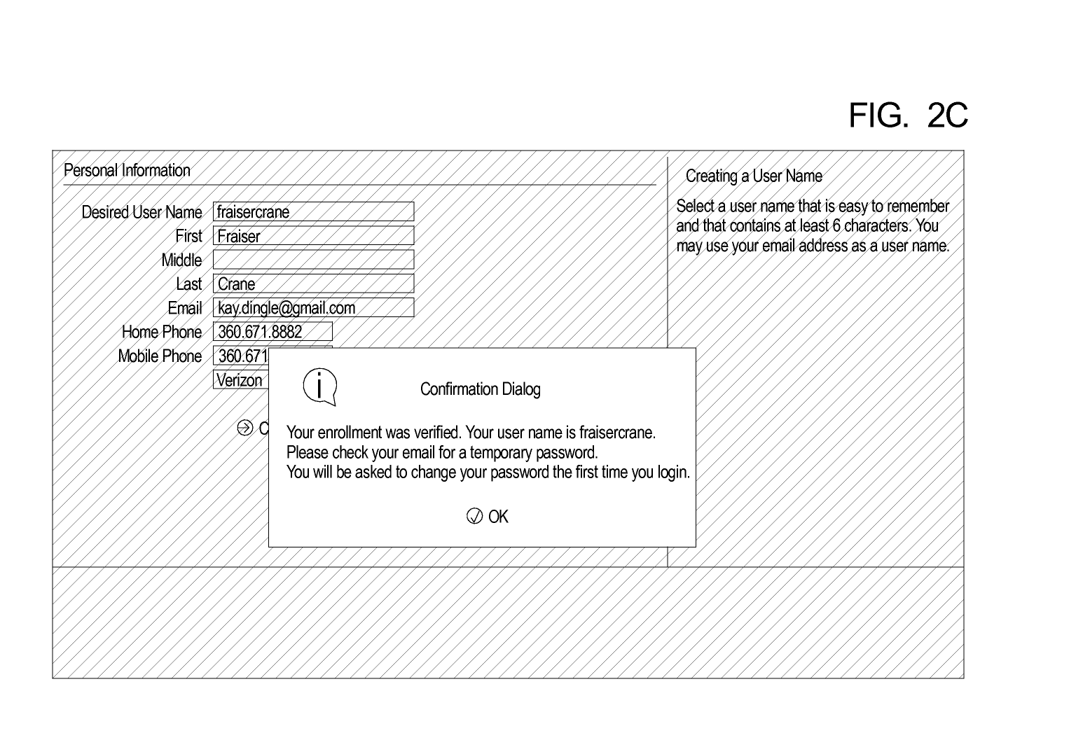

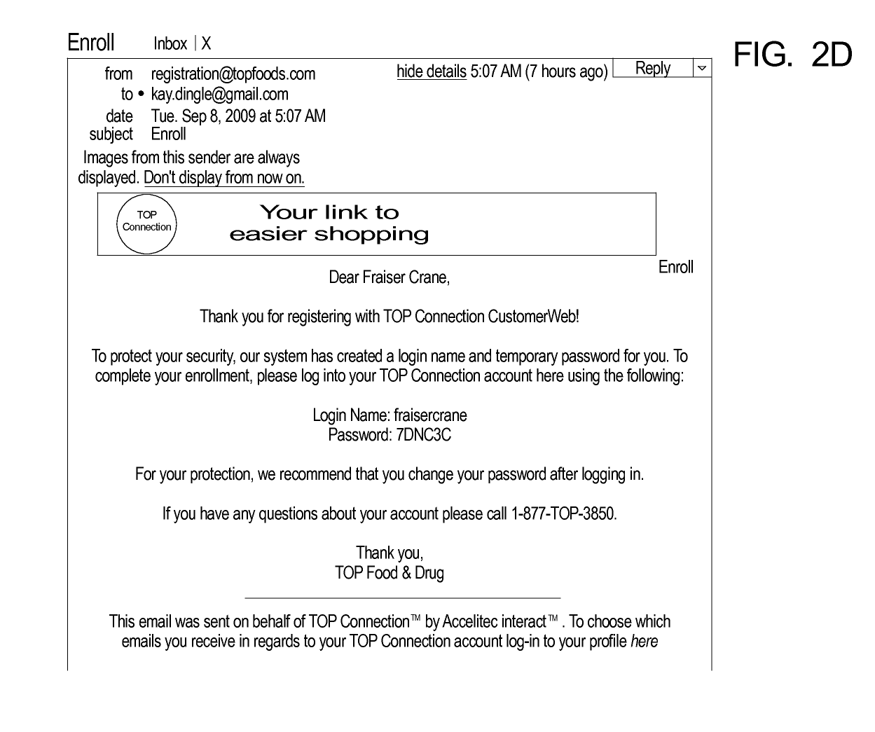

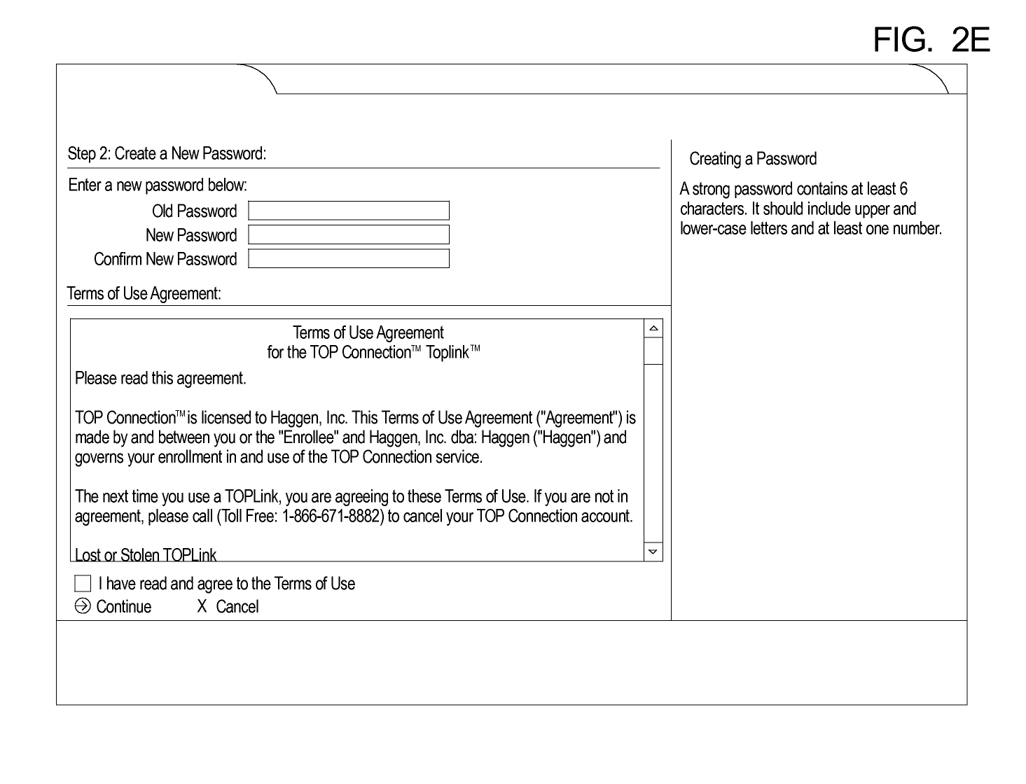

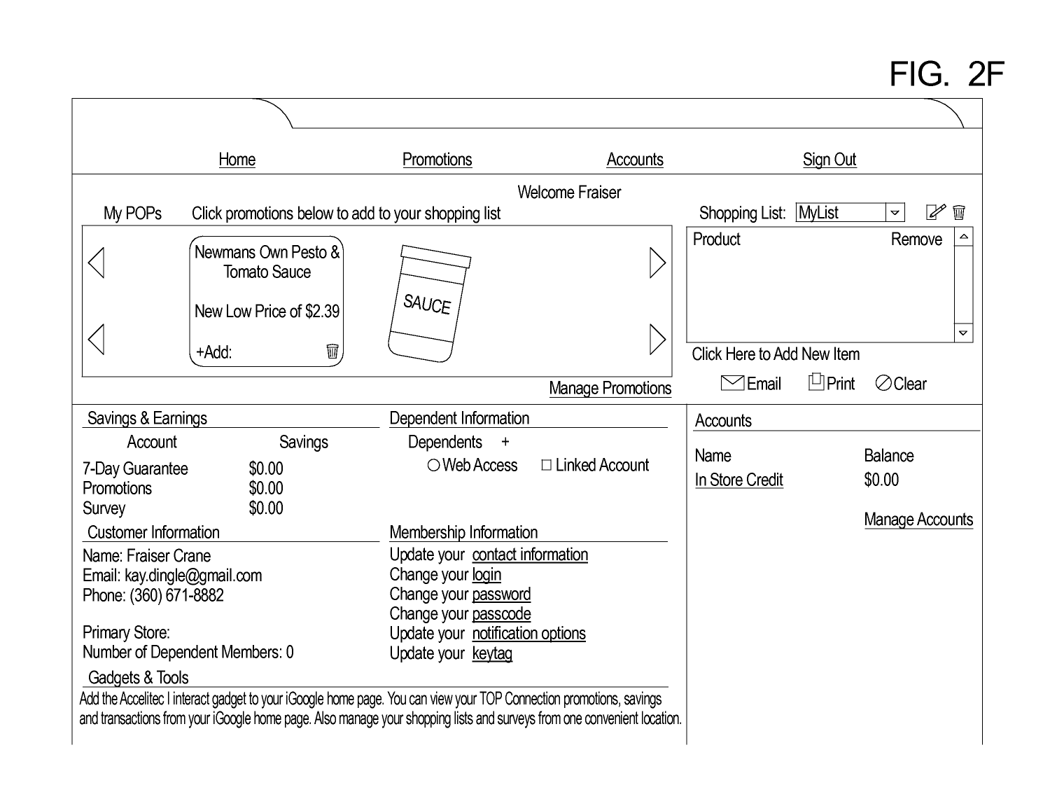

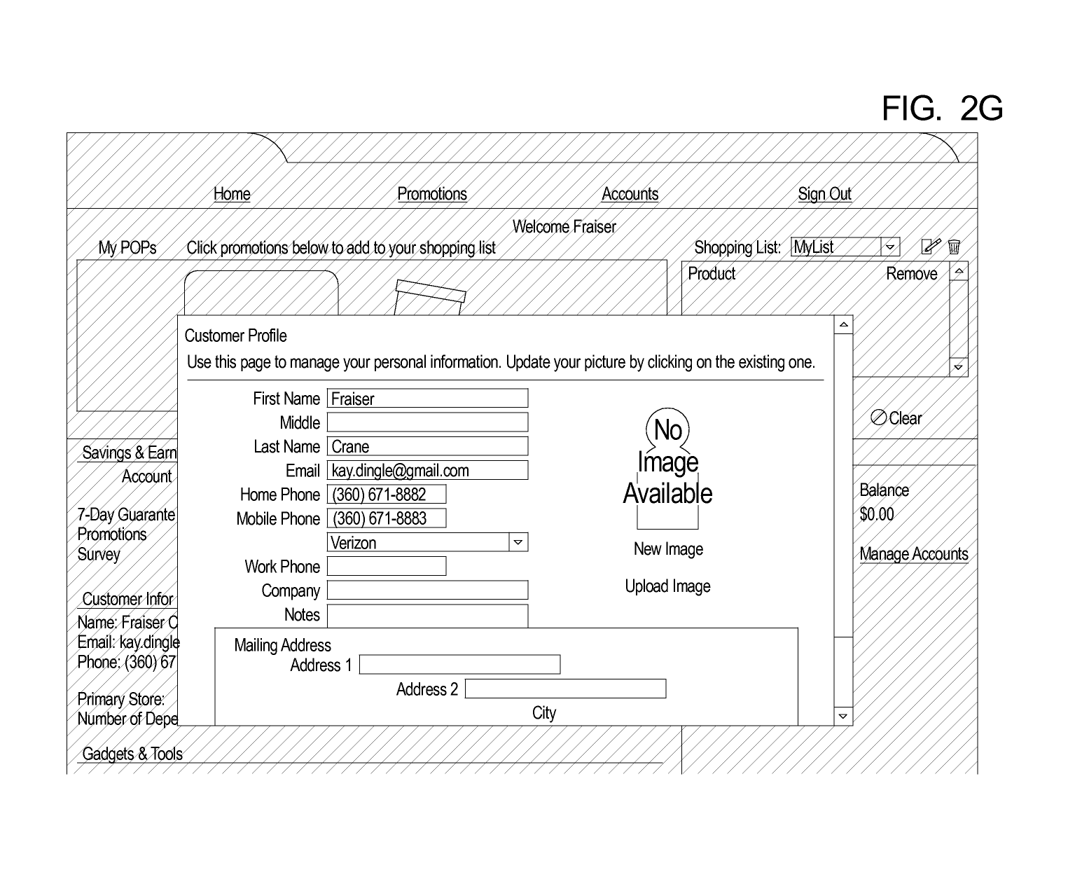

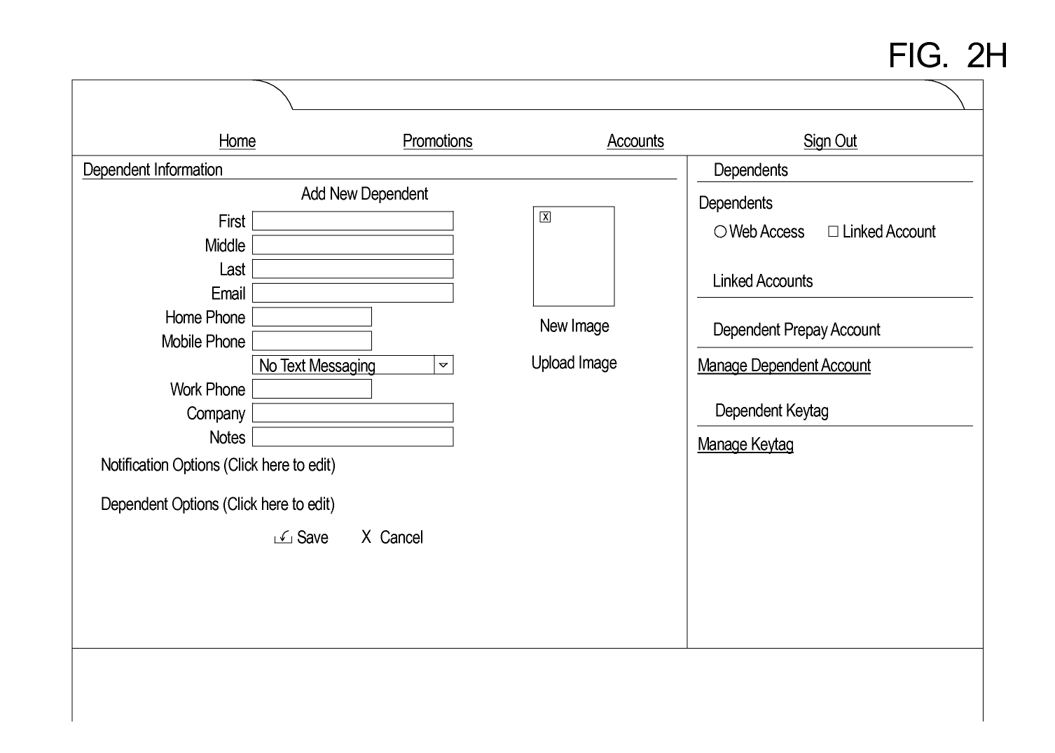

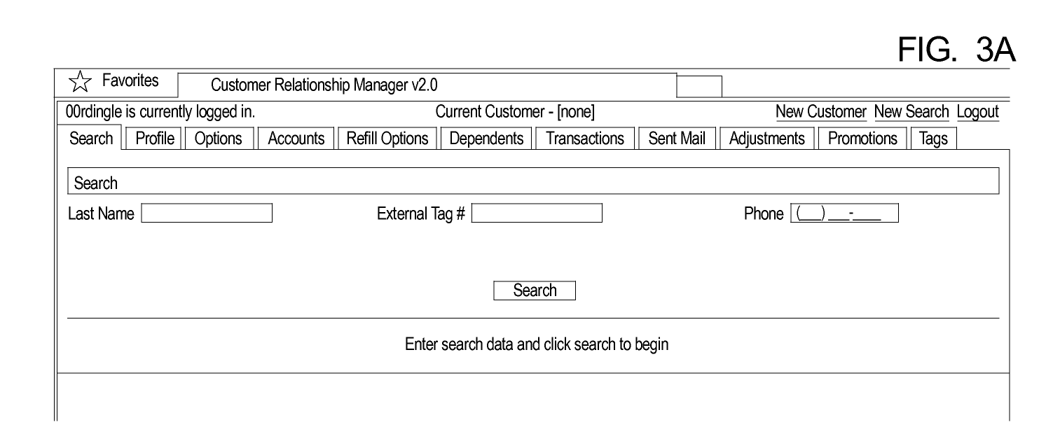

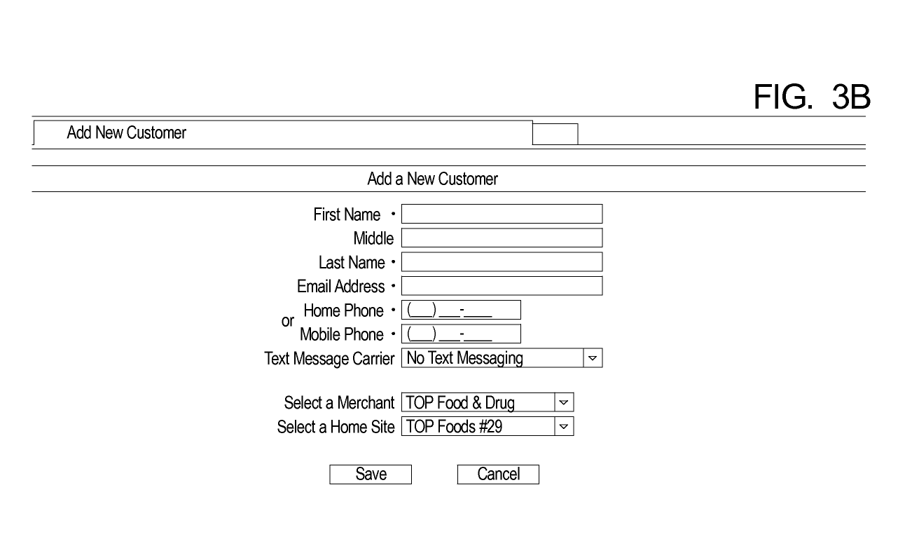

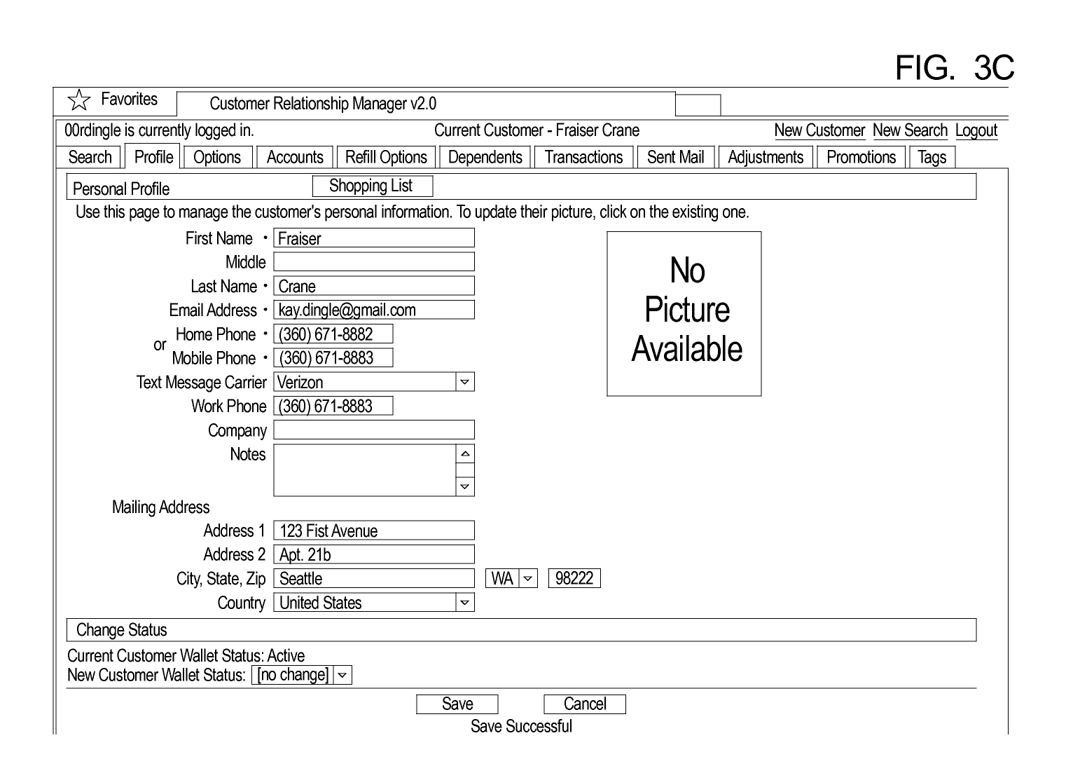

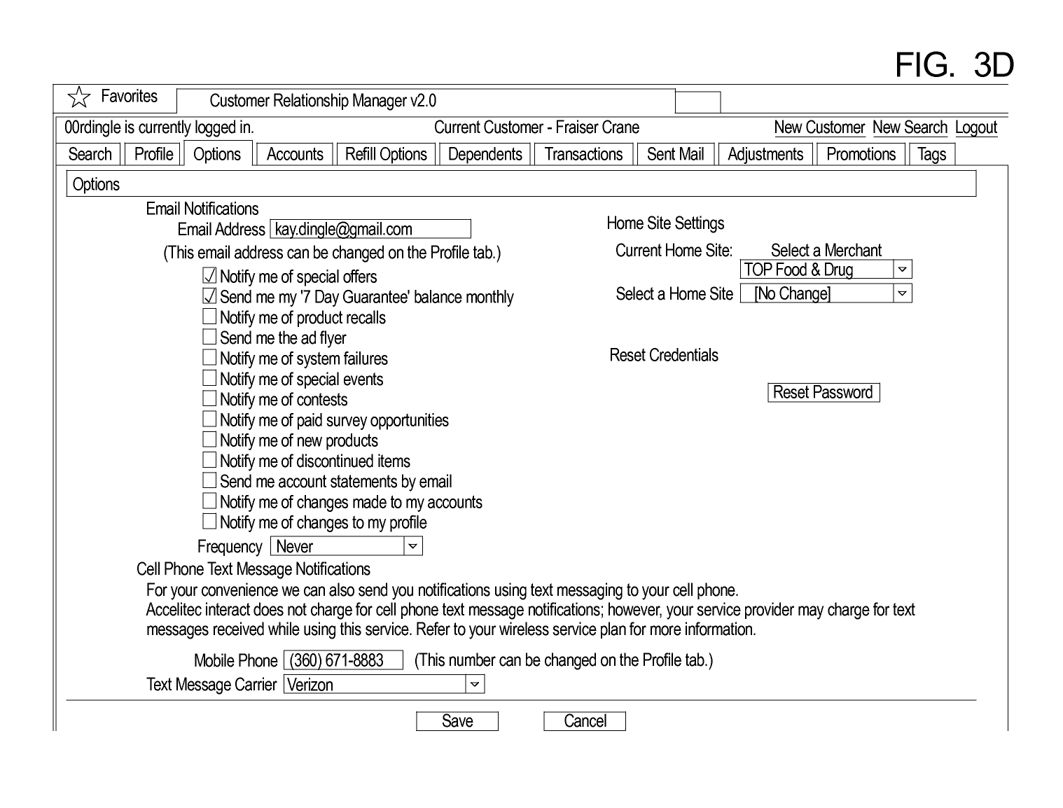

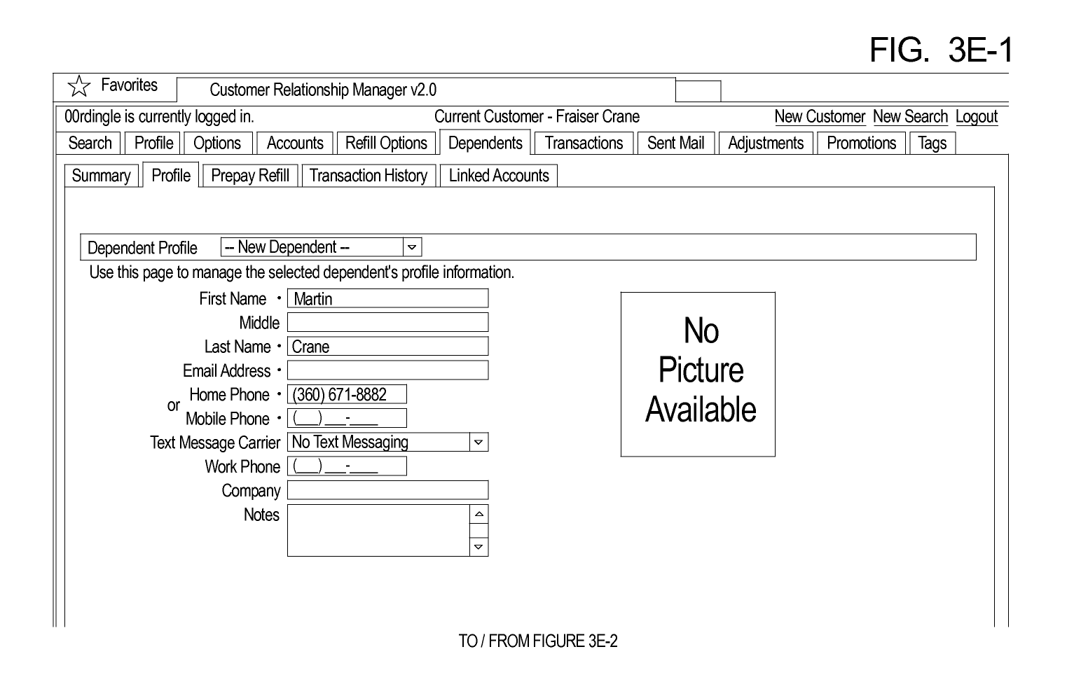

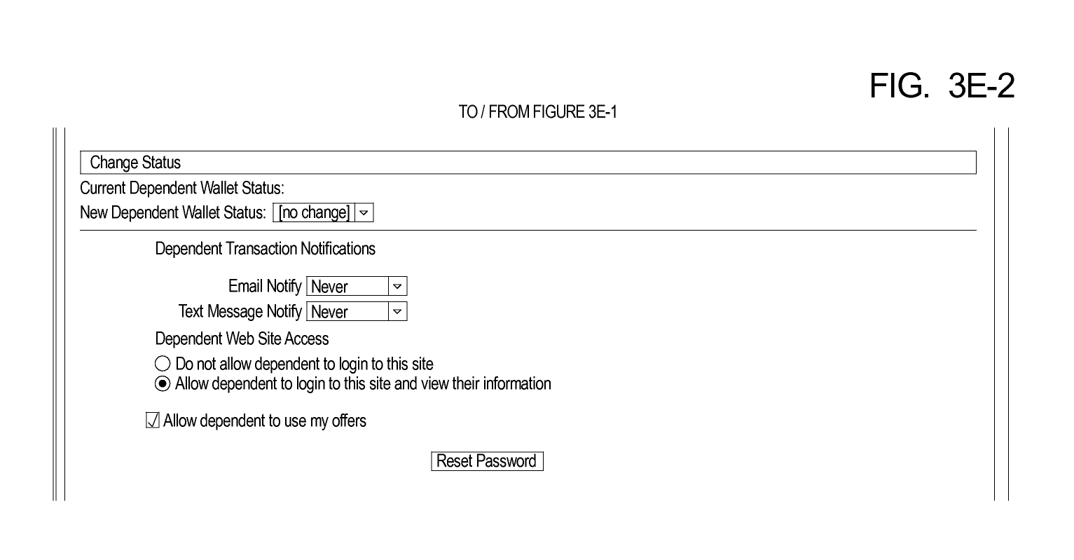

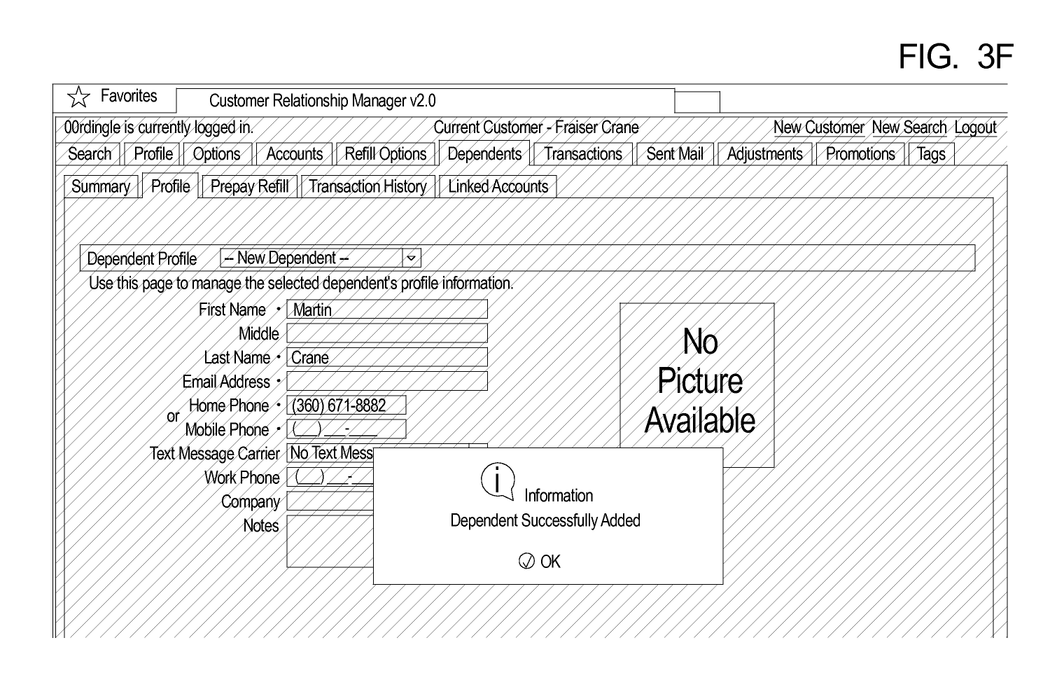

If anonymous enrollment is not desired, then customer data is entered into the system 25. The customer data may be entered over the internet via a customer web interface or a customer records management (CRM) web interface via a call center and/or an in-store service counter 25. Details regarding the customer web interface and the CRM web interface will be discussed in connection with FIGS. 2A-2H and FIGS. 3A-3F, respectively.

For sake of completeness, after the system creates a customer portfolio 30, a determination is made as to whether a piece of media (e.g., RFID tag) is available 35. The availability of a tag will be based on whether the customer is enrolling in-store or at a remote location. Even if a customer is enrolling in-store, there may be a physical unavailability of tags if the vendor has temporarily run out of tags.

If a tag is available to the customer, it is issued 20. If a tag is unavailable, a fulfillment number is issued 40 (described in more detail below). To obtain a tag, the customer is required to present the fulfillment number and secure tag profile data 45 (also described in more detail below).

FIGS. 2A-2H are screenshots for the customer web interface. The screenshots illustrate enrollment information that is used to create an electronic portfolio for a customer, along with options available to a customer with respect to managing his account. The enrollment information is entered by the customer on a website over a secure socket layer (SSL) connection.

For customers who have not yet enrolled, FIG. 2A includes a link that describes how to enroll (sign up to become a member). For customers who are already enrolled, areas are provided for a member to include their member login and password.

If the customer is a new enrollee, the customer will be directed to a page like that shown in FIG. 2B, where the customer is prompted to create a user name. In one embodiment, required contact information includes first name, last name, email address and re-entered email address. In one embodiment, the customer's title (salutation) and middle initial may be entered by the customer at the customer's option.

In one embodiment, the customer's first name and last name are not necessarily required to be an individual's actual name. For instance, the customer can use a pseudonym. In one embodiment, the customer's first and last name must be the customer's legal name and/or is verified by one of vendor's representatives prior to issuing the piece of media.

The system validates the availability of the requested username, email and phone data formatting, then displays a confirmation dialog indicating that the request was processed successfully FIG. 2C.

In one embodiment, the system generates an email to the newly enrolled member that contains a temporary password that must be changed during their first login to the Customer Web site FIG. 2D.

The customer returns to the main Customer Web landing page, enters their user id and temporary password, and is then prompted to create a new password FIG. 2E.

In one embodiment, the system also includes one or more password questions, which may be used in case the customer forgets his password. In addition, a security check is provided to thwart efforts by automated programs to surreptitiously change login and password information.

FIG. 2G is a contact information page. A customer is required to enter at least one telephone number and identify which of the one or more telephone numbers is his primary number for purposes of interacting with the system and for future authentication, as will be described in more detail later in this application.

The customer may also be required to enter a mailing address. If the customer's physical address is different from the customer's mailing address, the customer is prompted to enter his physical address.

Furthermore, the customer is requested to specify his preferences as to how the system contacts him with respect to certain subjects. For example, if the vendor begins offering a new item that, based upon the customer's purchasing history, may be of interest to the customer, the system will send the customer an email, send the customer a text message or will not contact the customer at all, as specified by the customer's indicated preference. In the illustrated example, being notified by telephone is not an option for the customer, although this option could be made available. In one embodiment, the system may notify the customer of a new item regardless of the customer's purchase history.

As another example, if a product (or service) has been discontinued and the customer has previously purchased such item, the system will send the customer an email, send the customer a text message or will not contact the customer at all, as specified by the customer's indicated preference. In the illustrated example, being notified by telephone is not an option for the customer, although this option could be made available. In one embodiment, the customer can opt to receive a notification regarding discontinued items (products or services) regardless of whether the customer previously purchased such items.

As yet another example, if a product has been recalled and the customer has previously purchased such item, the system will send the customer an email, send the customer a text message, contact the customer by telephone (either by delivering an automated message or instructing one of vendor's representatives to call) or will not contact the customer at all, as specified by the customer's indicated preference. In one embodiment, the customer can opt to receive a notification regarding recalled items regardless of whether the customer previously purchased such items.

As yet a further example, if a product (or service) is the subject of a price guarantee program and the customer will be receiving (or has received) a credit associated with a price difference, the system will send the customer an email, send the customer a text message or will not contact the customer at all, as specified by the customer's indicated preference. In the illustrated example, being notified by telephone is not an option for the customer, although this option could be made available.

As a final example, the customer may specify the manner by which he will receive the vendor's flyer. In the illustrated example, the flyer may be received by email or not received electronically at all.

In one embodiment, the customer has the ability to update his contact information including, for example, changing or adding telephone numbers, changing the customer's primary number, changing the customer's mailing address, changing or adding the customer's physical address and/or changing contact preferences.

FIG. 2H is an additional family member (dependent) page. Instead of family members having separate accounts, the system allows the customer that is the primary registrant to add family members (or more broadly, secondary registrants) to his account.

In addition to specifying the additional family member's name, the customer is given an option to allow the family member to access all or a portion of the customer's forms of payment that are associated with the primary registrant's account (e.g., in-store credit account). To do so, the customer who is the primary registrant would check the box associated with “Can use Funds.” An option is also given to add another family member. If the option to add another family member is selected, the customer who is the primary registrant is prompted for the additional family member's name and whether the additional family member is allowed to access all or a portion of the customer's forms of payment that are associated with the primary registrant's account.

After a family member is added to the account of the customer that is primary registrant, the customer has the option of deactivating and/or reactivating the family member. This is done by a checking a box associated with “Do you want to INACTIVATE this member?” or “Do you want to ACTIVATE this member?” functions (or their equivalents), as appropriate.

Once the initial data has been entered, a fulfillment number is provided to the customer who is the primary registrant by forwarding same to the email address of the primary registrant. In one embodiment, separate fulfillment numbers are provided for secondary registrants, so that media is securely assigned to the secondary registrants (see further below). In one embodiment, such separate fulfillment numbers are forwarded to the email address of the primary registrant. In one embodiment, such separate fulfillment numbers are forwarded to the email address of the secondary registrant and/or the email address of the primary registrant. In one embodiment, the fulfillment number is generated from a secure external or internal database.

The customer who is the primary registrant (or the secondary registrant if the fulfillment number is delivered to the secondary registrant's email address or if directed by the primary registrant to do so) then prints the fulfillment number (or otherwise notes it) and brings it to the vendor's customer service counter or to a point of sale terminal. The vendor's representative will enter the fulfillment number and verify the customer's identity (e.g., reviewing a driver's license, reviewing a passport or using the primary telephone number provided during enrollment), after which a piece of media is issued to the customer.

In one embodiment, the pieces of media associated with each account of a secondary registrant are linked with the primary registrant's account. If the primary registrant's account is ever suspended or terminated, the secondary registrants' accounts also become suspended or terminated.

In one embodiment, a third party issues fulfillment numbers and is (hosts) the database of record for the vendor with respect to the customer profile and loyalty program. In order to ensure that extensive security is provided between the third party and the vendor prior to issuing a piece of media that is associated with a customer profile, a sophisticated security solution is provided as shown in FIG. 3. Specifically, the credentials or MAC addresses of all devices that communicate with the third parties' database, application and web services are registered with the third party in advance of any communication. If a device that is not registered attempts to communicate with the third party's database, application and/or web services, such device will be rejected.

When a registered device attempts to communicate with the third party, the third party's certificate server will issue that device a trusted root and client certificate. These certificates are the authentication tools, which (in one embodiment) allows any and all future communication between the third party and the device.

In one embodiment, when using an authenticated registered device, the user (e.g., a vendor's employee or representative) must be issued a user name and password prior to initial login. The user name and password is registered with the third party in advance of any communication with the user as shown in FIG. 3. At the time the user's profile is created, a user name and password is assigned to specific site(s), location(s) or device(s). Therefore, that user can only successfully login to the third party's system (e.g., server) on a site/location/device where he is registered. In one embodiment, the user authentication must take place for each new transaction by the user with the system. In one embodiment, the user is authenticated at login and remains authenticated until logout. In one embodiment, the vendor determines the specific site(s), location(s) or device(s) where a user may login. In one embodiment, the third party makes such determination either alone or in conjunction with the vendor.

FIG. 2H is a member edit page. It provides a customer with an interface whereby the customer can edit personal information, edit contact information, edit information about the customer's interests, edit family members (including adding or removing a family member, setting permissions as to whether and which family members can use funds in customer's account and setting whether a particular family member is active or inactive) and changing the customer's password. A summary of the present customer-profile settings is also provided.

FIGS. 3A-3F are screenshots of a customer records management (CRM) graphical user interface (GUI), which illustrate enrollment information that is used to create a customer account, along with options available to a customer with respect to managing his account. The CRM GUI is available to vendor's representatives, who are located in stores or at a call center. The CRM GUI is made available via a secure system. In one embodiment, the secure system is the system shown in FIG. 3 or a subset thereof. The secure system also requires an SSL connection.

As shown in FIG. 3A, when a new customer profile was to be created, vendor's representative would select “New Customer.” As shown in FIG. 3B, the vendor's representative is then prompted to enter a store name, for example, if a loyalty program is only offered at less than all of the vendor's stores.

The vendor's representative is prompted to obtain and enter information from the customer, as shown in FIGS. 3C, 3D, 3E (formed by a combination of 3E-1 and 3E-2) and 3F. The information to be obtained from the customer in FIG. 3C generally corresponds to the information requested from the customer in FIGS. 2B and 2H. Therefore, for sake of brevity, a description of FIG. 3B will not be provided herein, as one skilled in the art would readily understand FIG. 3B in light of the description provided in connection with FIGS. 2B and 2H.

In one embodiment, the CRM Web contains a customizable personal profile page. Vendor's representative requests the customer to provide some basic personal information, such as his date of birth, household size, income range, children's ages, types of pets, etc. The customer is also requested to identify (from a list) things that are of interest to the customer (e.g., cooking, gourmet food, health & wellness, local products, natural/organic food, wine and other). Vendor's representative may also ask the customer to provide information regarding customer's shopping preferences by category, e.g., dietary preference, brand name, etc. It should be noted that a personal profile page may also be provided when a customer register's via the customer web interface.

The information to be obtained from the customer in FIG. 3B generally corresponds to the information requested from the customer in FIG. 2G. Therefore, for sake of brevity, a description of FIG. 3B will not be provided herein, as one skilled in the art would readily understand FIG. 3B in light of the description provided in connection with FIG. 2G.

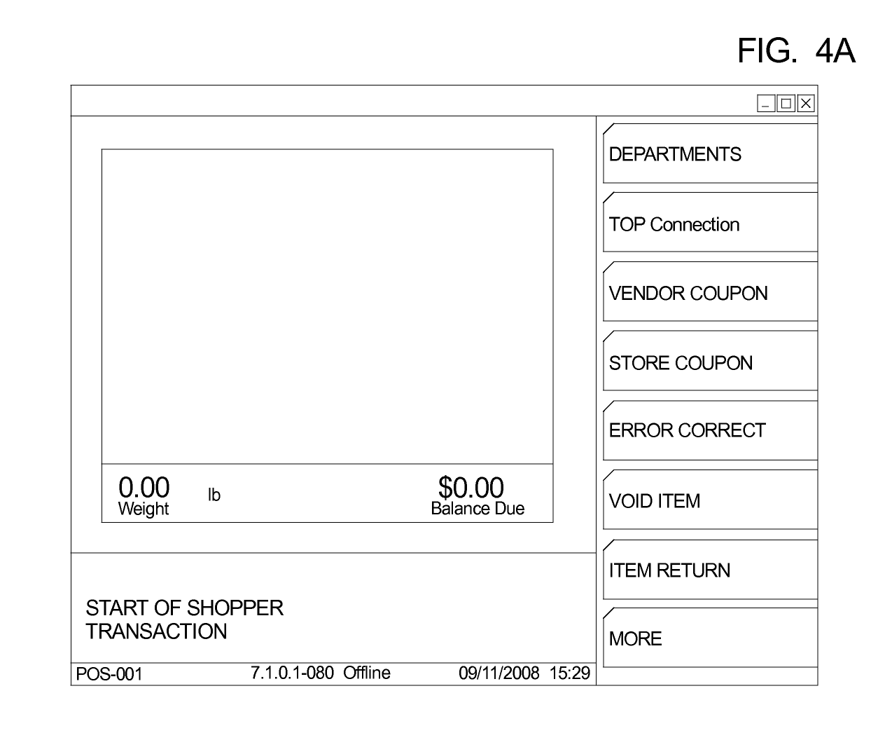

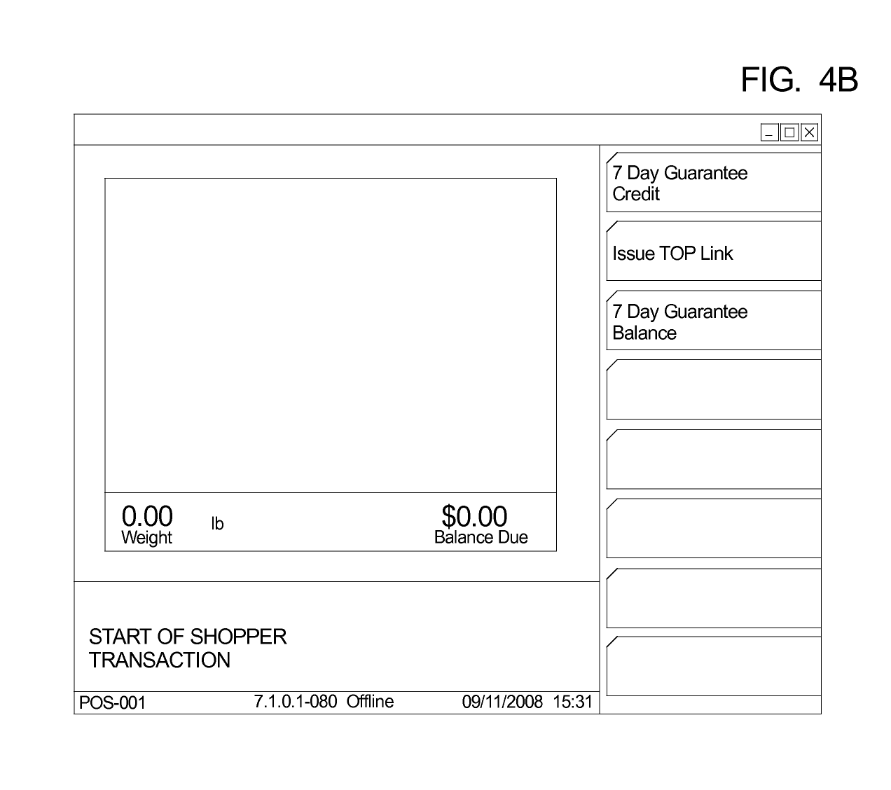

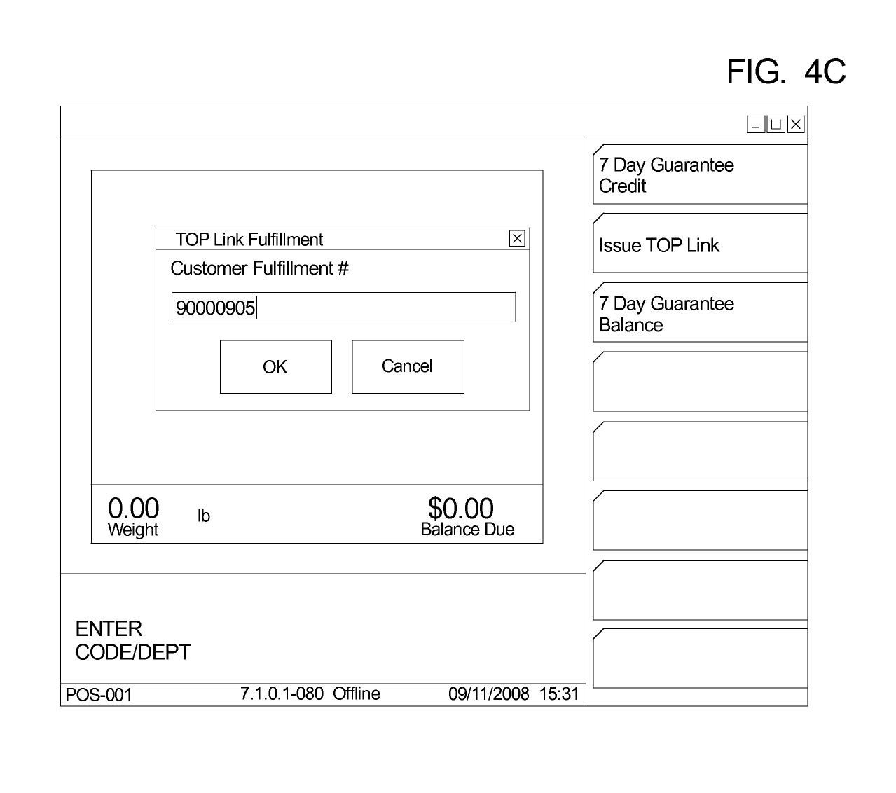

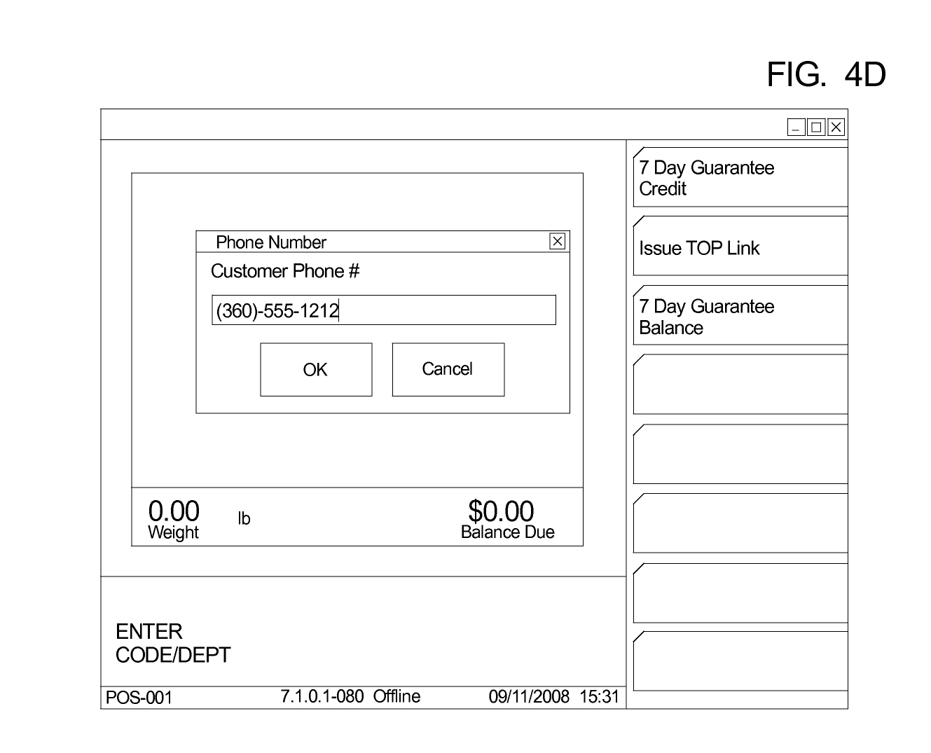

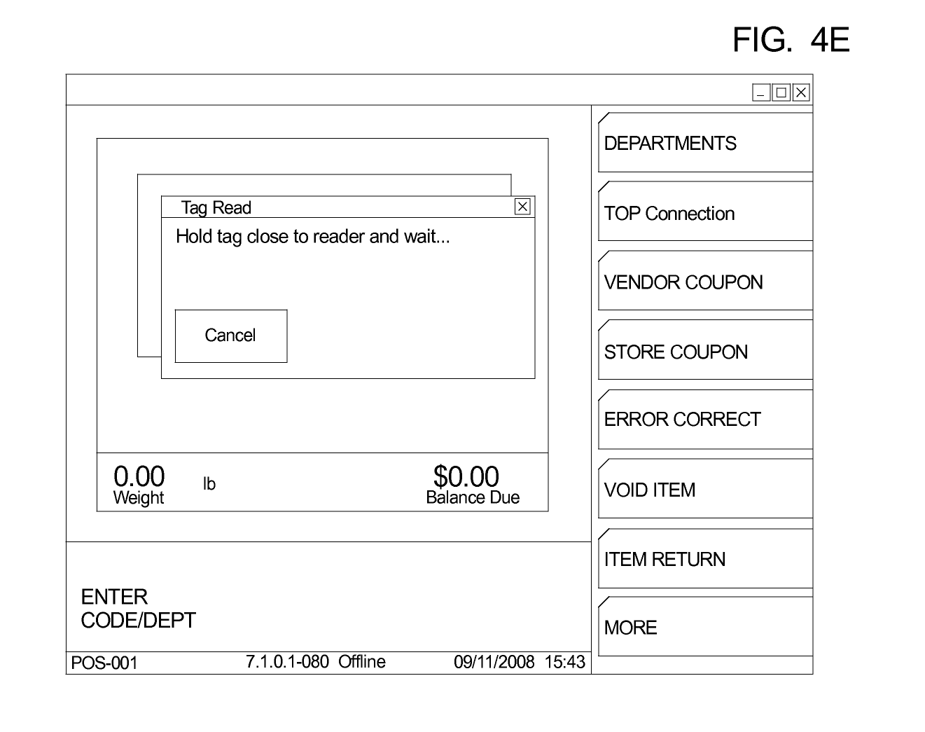

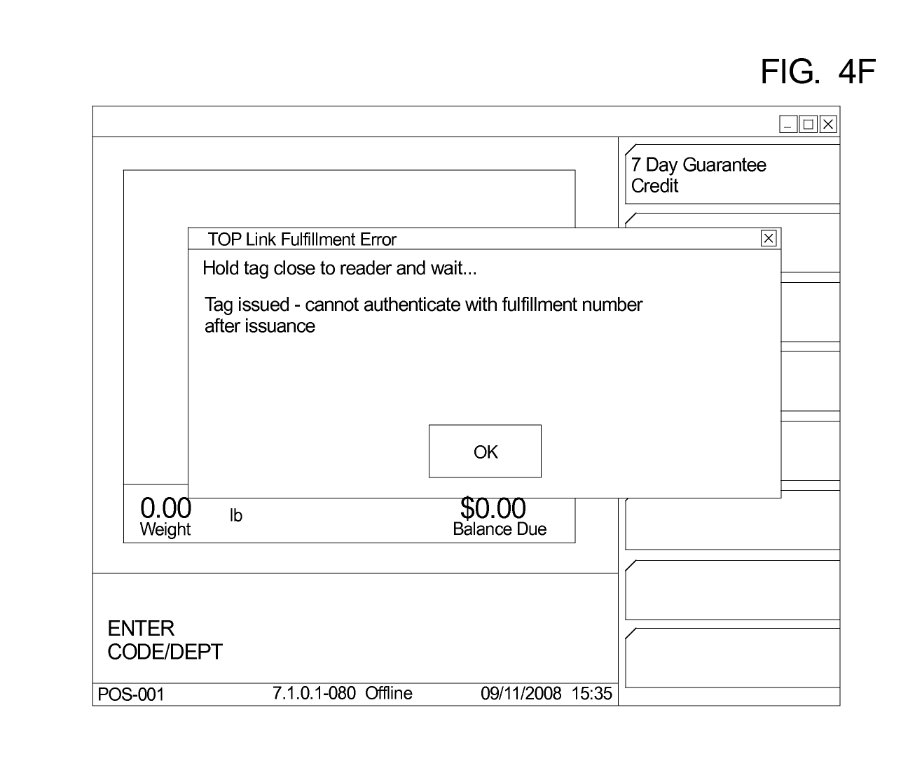

FIGS. 4A-4F are screenshots of a display at a point of sale terminal, which illustrate the use of a fulfillment number to securely obtain a piece of media (e.g., an RFID tag) that is associated with a customer profile.

FIG. 4A illustrates a number of operator options along the right side of a touch screen (or similar) display. Among the options is a tab associated with TOP Connection, which is a customer loyalty program that uses certain embodiments of the present invention. When a customer presents a fulfillment number, the operator selects the TOP Connection tab.

Subsequently, the operator is brought to a screen that looks like the one shown in FIG. 4B, which illustrates three additional operator options. To continue the process of issuing a piece of media associated with a customer profile, the operator selects Issue TOP Link.

Next, the operator is prompted to enter a customer fulfillment number, as shown in FIG. 4C. Furthermore, as an additional form of security (e.g., in case someone, other than the customer to whom the fulfillment number was issued, obtains the fulfillment number), the operator is prompted to enter a customer telephone number that is associated with the customer's account profile (see FIG. 4D). This provides a higher degree of confidence with respect to customer authentication before a piece of media is issued.

Instead of, or in addition to, a fulfillment number and the telephone number, the system could require a customer to provide some other form of customer authentication, such as a driver's license, credit card and/or other form of identification. Such information could be compared to the name associated with the data entered into the customer's account profile.

Since the customer fulfillment number is associated with a customer profile and since the customer was required to provide his telephone number when his customer profile was created, a verification is performed to ensure that the telephone number matches the primary telephone number (or at least one of the telephone numbers) included in the account profile. If the verification process is successful, the operator is prompted to hold the piece of media (in this case, an RFID tag) close to a reader (see FIG. 4E) and the media then becomes activated (i.e., associated with the customer profile) and ready for use.

If the verification process is unsuccessful, the operator is so notified (see FIG. 4F). In some cases, the reason that the media cannot be activated is communicated to the operator. For example, the media cannot be activated if the fulfillment number has already been used to activate another piece of media or if the telephone number does not match the primary telephone number (or at least one of the telephone numbers) associated with the customer profile.

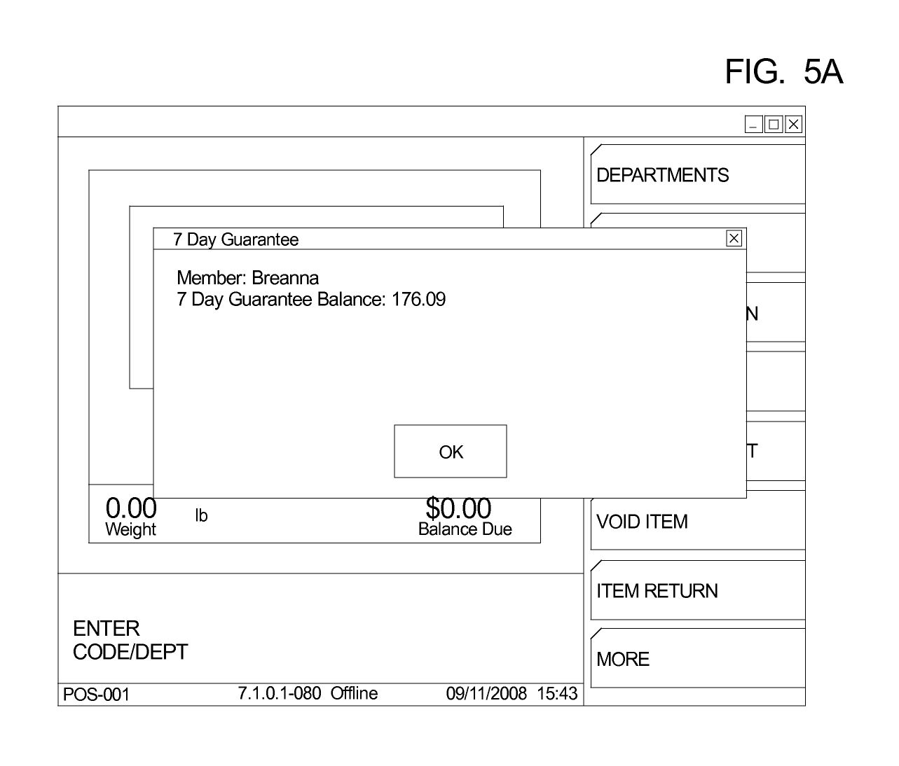

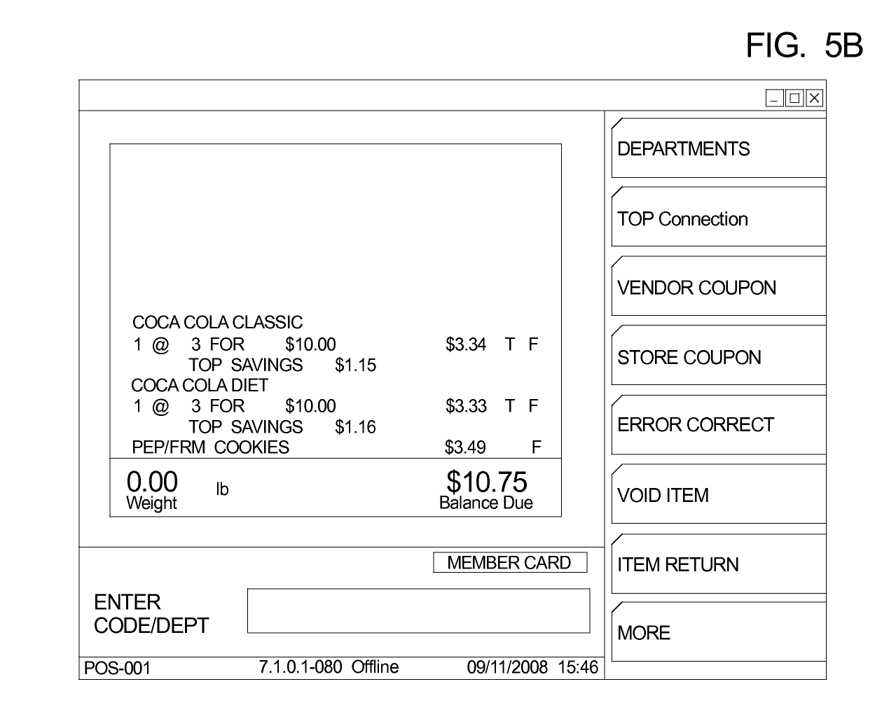

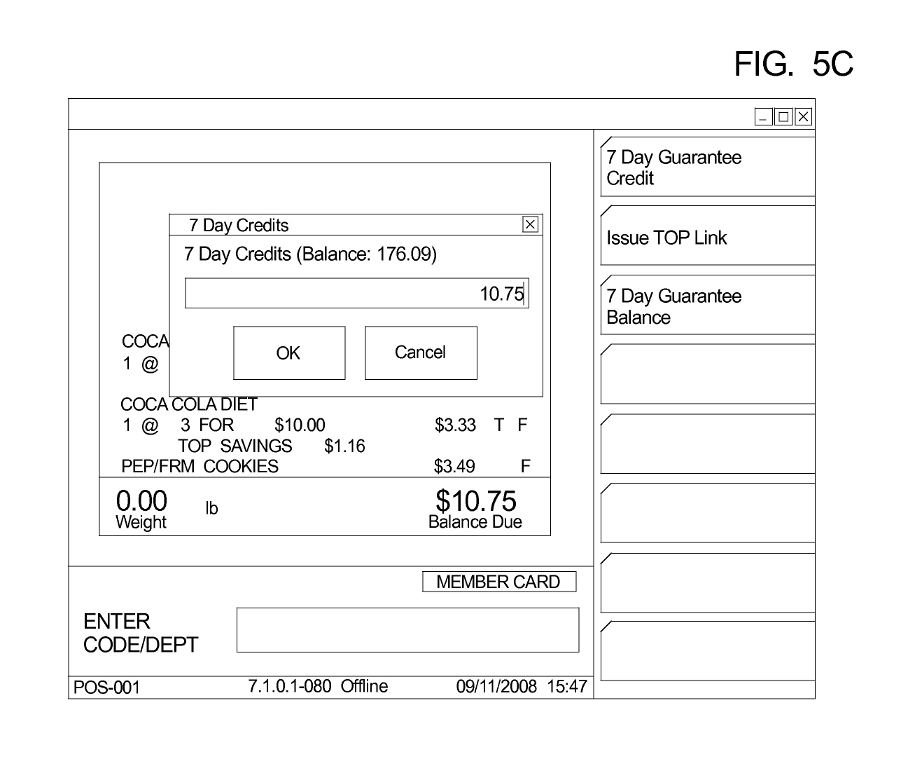

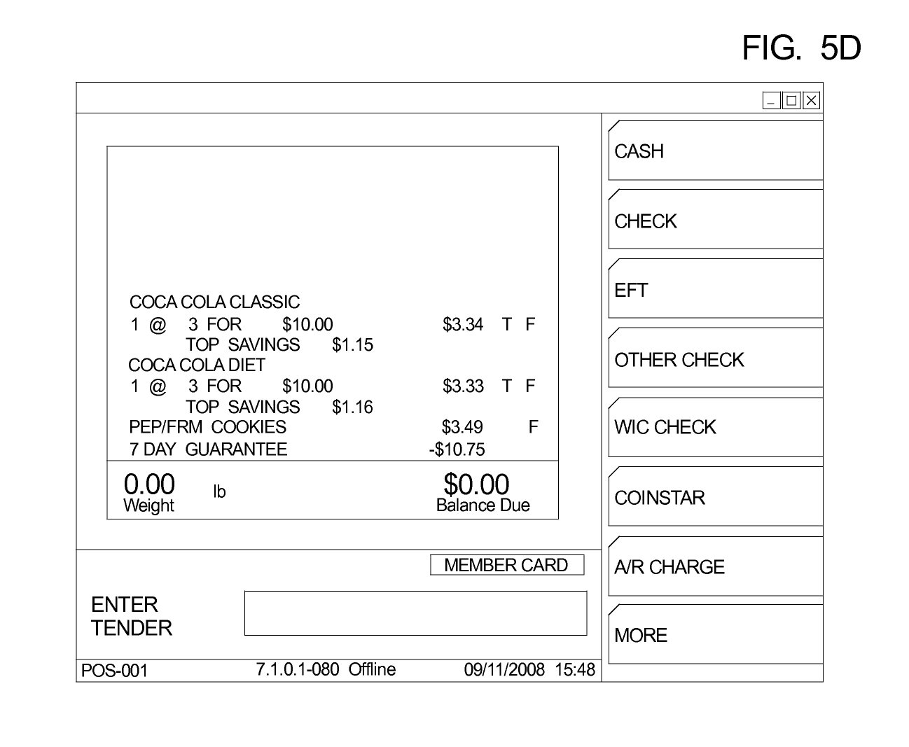

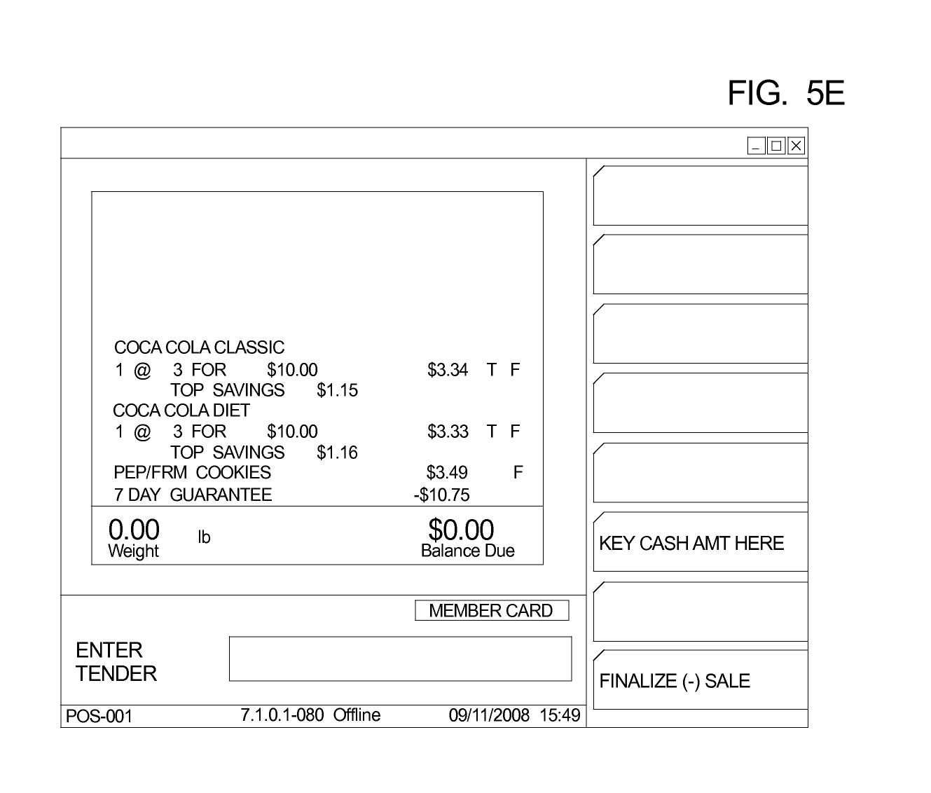

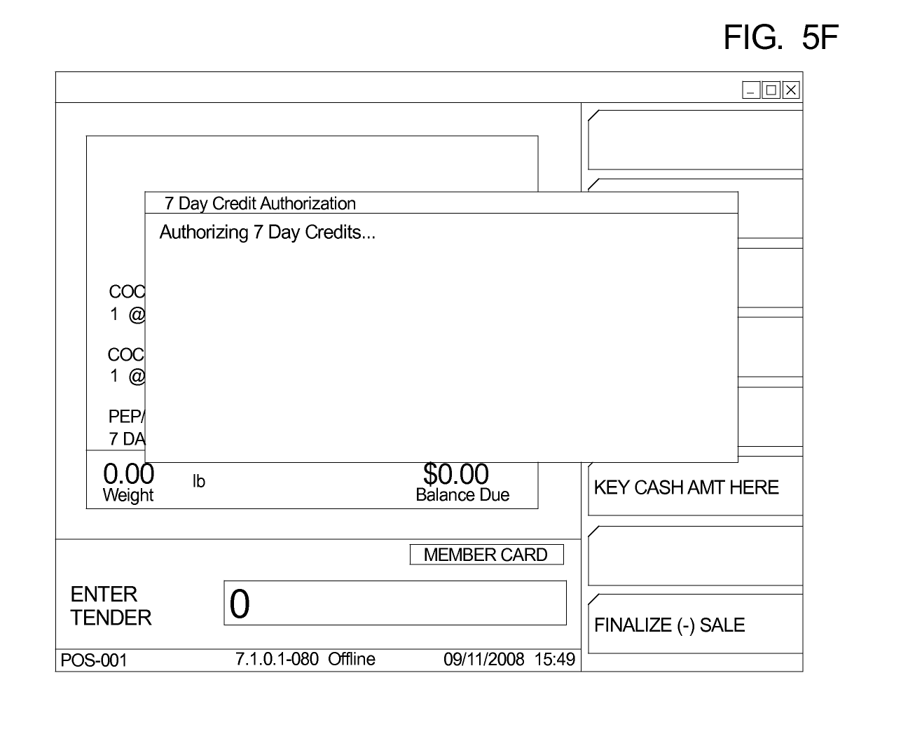

FIGS. 5A-5F are screenshots of a display at a point of sale terminal. The screenshots illustrate how an operator assists a customer in redeeming in-store credits (in this case, in-store credits that are associated with a 7 Day Guarantee). With reference to FIG. 4B, an operator touch-screen includes a tab for 7 Day Guarantee Balance.

After the operator selects such tab, a screen like that shown in FIG. 5A is displayed. Specifically, the screen shows the operator (and, optionally, the customer) the customer's name and the in-store credits available to the customer (either as a whole or just those in-store credits associated with a particular program). The operator can communicate the amount of the in-store credit balance to the customer and/or can direct the customer to the screen to view the balance. After the operator or customer presses OK, the operator is brought to a transaction screen like that shown in FIG. 5B.

As a bar code reader reads bar codes associated with the products (or such information is manually entered), information regarding the products being added to the cart for purchase is displayed on the transaction screen. The information may include the name of the product (or an abbreviation therefore), the product quantity, the price, any customer loyalty discounts and a (running) total of the balance due. In FIG. 5B, the balance due after all products have been scanned is $10.75.

Next, the customer is prompted as to whether the customer would like to redeem any of his in-store credits. If so, the operator selects the name of the customer loyalty program (in this case, TOP Connection) from the tabs on the right side of the screen in FIG. 5B.

Then, a screen like that shown in FIG. 4B is presented to the operator, except that the products in the cart and the total balance due are displayed. The operator selects 7 Day Guarantee Credit, so that credits may be redeemed and a screen similar to that shown in FIG. 5C is displayed. A pop-up box sets forth the in-store credit balance associated with the customer's profile and prompts the operator to enter the amount of the in-store credits to be redeemed.

In FIG. 5C, the customer has decided to redeem in-store credits equal to the entire balance due. (Other options and restrictions associated with the use of in-store credits are discussed in the sample implementations at the end of this application.) After entering the amount of in-store credits to be redeemed, the operator selects OK and a screen like that shown in FIG. 5D is displayed.

FIG. 5D shows that in-store credits associated with a program entitled 7 Day Guarantee in the amount of $10.75 are to be redeemed. In one embodiment, the operator is required to select a payment type (e.g., cash) from the list on the right side of the screen, so that a screen like that shown in FIG. 5E may be displayed.

As shown in FIG. 5E, the operator is given the option of selecting a tab to enter a cash amount or selecting a tab to finalize the sale. Since no balance is due, the operator selects Finalize Sale and a screen like that shown in FIG. 5F is displayed.

In FIG. 5F, a dialogue box pops-up to indicate that in-store credits, associated with the customer's profile and associated with a program entitled the 7 Day Guarantee Credits, are being authorized. Behind the scenes, an in-store credit database is checked to determine that the requested in-store credits are available for the customer profile associated with the piece of media (e.g., RFID tag). Furthermore, once the in-store credits have been applied to the transaction, the in-store credit database is updated to reflect the remaining balance in the in-store credits account associated with the customer profile (and, hence, associated with the piece of media).

It should be noted that the term operator is not limited to one of vendor's employees or vendor's representatives. For example, the operator may be the customer when the customer is using a self checkout station.

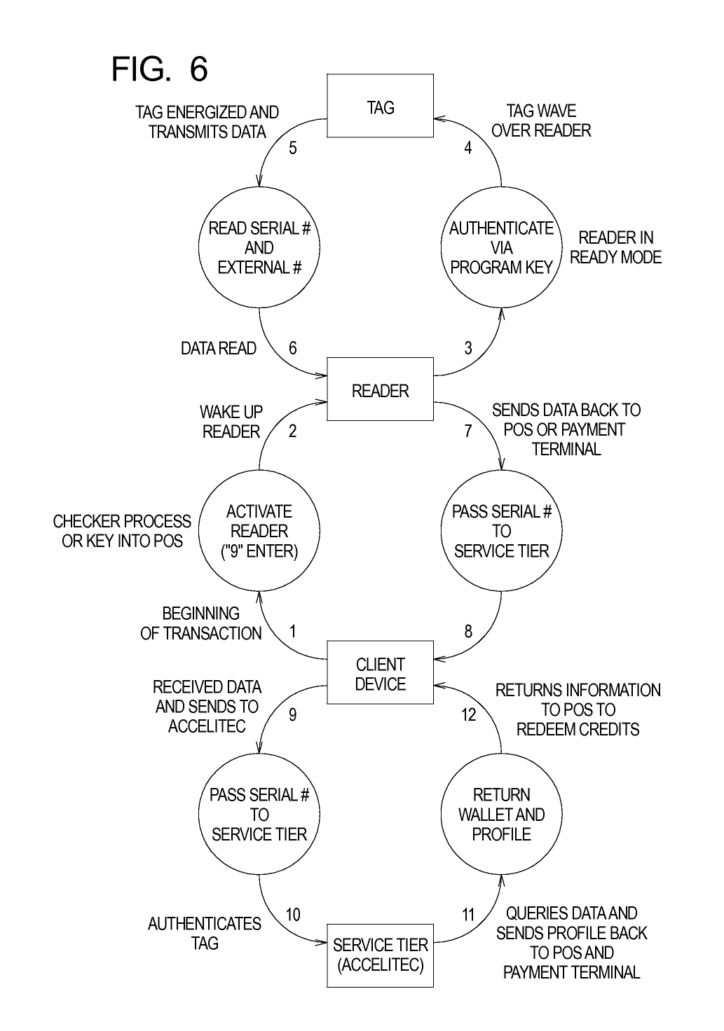

FIG. 6 is a flow diagram demonstrating the processes by which a tag is authenticated and a user profile is returned to a point of sale terminal. As a first step, a customer brings the piece of media (e.g., an RFID tag) associated with his customer profile to a client device (e.g., a point of sale terminal). This begins the transaction.

Next, a media reader is awakened by the entry of one or more keystrokes into the point of sale terminal (e.g., by depressing the number 9 and enter) or by some other action by the operator. In some embodiments, the reader does not need to be awakened.

Then, the reader is placed into a ready mode, whereby it waits for the tag to be placed in proximity to the reader and whereby it waits to receive the data being transmitted by the tag, so that the tag may be authenticated by the program key. The program key is a record stored in a database that is specific to a vendor's program and lists the serial number and external number of tags that are permitted to be used with the program.

Subsequently, the customer waves the media over the reader (or slides the media through the reader). In the case of an RFID tag, the tag is then energized by the magnetic field that emanates from the reader and the tag transmits data. The data includes the tag's serial number and the tag's external number.

Next, the data is read by the reader and at least part of the data (e.g., the tag's serial number) is communicated to the point of sale terminal (or, in some cases to a payment terminal, e.g., a credit card or debit card reader). The point of sale terminal then communicates the received data (e.g., tag's serial number) to an external third-party database, where the media is authenticated (as described above). In one embodiment, the database is not a third-party database, nor is it external.

Next, customer profile information is communicated from the database to the point of sale terminal or the payment terminal. The customer's profile information may include the amount of in-store credits available to the customer, along with some or all of the information entered into the customer's account profile.

The amount of available in-store credits communicated from the database to the point of sale terminal (or the payment terminal) may then be redeemed by the customer subject to, in some cases, to a verification process. For example, just prior to the transaction being completed and credits being redeemed, the amount of in-store credits available to the customer are again verified.

Some sample implementations of services that may be offered as part of a customer loyalty program are described below. The services include an automatic price guarantee, an automatic product recall notification, a remote refund process and automatic notifications.

In one embodiment of the present invention, a customer account is created that associates a customer with product purchases. In setting up the account, a customer provides enrollment information such as the customer's name, address, telephone number, email address and mobile telephone number. Furthermore, the customer account may be associated with a key fob, card (including radio frequency identification device (RFID) tag) or other media. When the customer account is created, an in-store credit account is automatically created for the customer, and price guarantee credits are automatically credited to such account.

The customer account includes a pending credit account associated with a pending credit database and an in-store credit account that is associated with an in-store credit database. Details regarding the pending credit account and the in-store credit account are provided further below in this application.

A. Automatic Price Guarantee

In one embodiment of the present invention, when a customer account (e.g., a customer loyalty account) has been created, customer purchases associated such customer account are tracked and stored in a data warehouse in the form of transaction data. As described above, the transaction data may include a transaction number, store number (in case of multiple vendor stores), register number, transaction date, transaction start time, transaction end time, products purchased, price of each product purchased, order in which each of the products were purchased and customer account number, among other things.

In one embodiment, the data warehouse also includes a business intelligence engine that can analyze, extract, reorganize and/or present the data stored in the data warehouse. In one embodiment, the business intelligence engine does not “reside” in the same location as the warehouse, but has access to the data therein.

When the price of a product (or service) is reduced within a specified time period from the original purchase date, the business intelligence engine is used to identify customer accounts that purchased the product during such time period. Under the price guarantee program of the present invention, such accounts are entitled to a credit associated with the difference between the original purchase price and the reduced price.

In one embodiment, if the price is reduced a second amount, which is greater than the first price reduction, within the specified time period from the original purchase date, the customer account would be entitled to a second credit.

In one embodiment, credits are given only to select products that have had their price reduced within the specified time period. For example, credits may be given only for those products that have had their prices reduced are advertised in the vendor's flyer, but not for other products whose prices were reduced. As another example, credits may be given only for those products that are in a particular department of the vendor's store (e.g., produce department or floral department), but not other departments.

In one embodiment, the credit to the customer account is greater than the price difference. In one embodiment, the credit to the customer account is less than the price difference. In one embodiment, the credit to the customer account is equal to the price difference.

At first, the credit is stored in a pending credit database that is associated with the customer account. When credits are stored in the pending credit database, a customer cannot access or use such credits.

At a predetermined time (e.g., each month on a particular day of the month), credits are “transferred” from the pending credit database to an in-store credit database on a per customer basis. In one embodiment, the predetermined time is defined by the vendor's business rules. In one embodiment, the number of credits to be transferred from the pending credit database to the in-store credit database is reported to the vendor prior to the transfer occurring. In one embodiment, the vendor authorizes the transfer before it occurs.

Credits stored in the in-store credit database may be accessed by the customer. It should be note that, in one embodiment, in-store credits are not the same as a cash account. That is, the monetary value associated with the in-store credits cannot be redeemed for cash. Instead, in-store credits may only be redeemed/applied against in-store purchases.

For example, when checking-out at a point of sale terminal, the customer presents his key fob, card or other media, which is read by a reader and includes the customer's account information. The customer account information is used to access the in-store credit database and the available in-store credits are displayed at the point of sale terminal.

Once a total price has been established for the products to be purchased, the customer is given the option of redeeming the in-store credits associated with his account in connection with purchasing the products. At the customer's option, the customer may redeem only a portion of the in-store credits and may pay the remaining balance using another form of payment (e.g., cash, check, credit card or debit card, etc.).

If the total price of the products being purchased is greater than the in-store credits associated with the customer's account, the customer may redeem all of his in-store credits and pay the remaining balance using another form of payment. If, however, the total price is less than the amount of in-store credits associated with the customer's account, the customer may only redeem in-store credits up to the total price. The customer is not entitled to receive “cash back.”

If the customer does not redeem all of his in-store credits in a single transaction, the balance of his in-store credits may be redeemed at a later date. In one embodiment, the credits do not expire.

When in-store credits are transferred from the pending credits database to the in-store credits database, a notification is sent to the customer. The notification can be in the form of an email or a text message (e.g., SMS notification). In one embodiment, the notification includes information regarding the amount of in-store credits being transferred from the pending credits database to the in-store credits database and the date that the in-store credits became available. In one embodiment, the notification includes the total in-store credit balance associated with the customer's account.

When in-store credits are redeemed, a notification is sent to the customer. Again, the notification can be in the form of an email or text message. In one embodiment, the notification includes information regarding the amount of in-store credits that have been redeemed and the date of such redemption. In one embodiment, the notification includes the remaining in-store credit balance after a transaction in which in-store credits have been redeemed.

In one embodiment, no notification is sent to the customer when credits are placed into the pending credit database. In one embodiment, a notification is sent to the customer when credits are placed into the pending credit database.

B. Automatic Product Recall Notification

As mentioned above with respect to the Automatic Price Guarantee, when a customer account (e.g., a customer loyalty account) has been created, customer purchases associated with such customer account are tracked and stored in a data warehouse in the form of transaction data. As described above, the transaction data may include a transaction number, store number (in case of multiple vendor stores), register number, transaction date, transaction start time, transaction end time, products purchased, price of each product purchased, order in which each of the products were purchased and customer account number, among other things.

In one embodiment, the data warehouse also includes a business intelligence engine that can analyze, extract, reorganize and/or present the data stored in the data warehouse. In one embodiment, the business intelligence engine does not “reside” in the same location as the warehouse, but has access to the data therein.

In certain circumstances, products that have been sold to consumers may be recalled. In one embodiment of the present invention, if a product is to be recalled, the business intelligence engine is used to identify customer accounts that purchased the product being recalled.

There are many reasons for product recalls. In some instances, recalls are imposed by the government. In other instances, a vendor may decide that a product does not meet its standards or requirements. Accordingly, the term product recall is not limited to those circumstances which are governmentally imposed.

Once a customer account has been identified, a notification is sent to the customer to advise the customer about the recall. Such notification may be in the form of an email, a text message, an automated telephone call and/or a live telephone call from the vendor or vendor's representative. In one embodiment, multiple notification efforts are made, especially if the recall involves a serious threat to health and/or safety.

In addition to sending a notification, appropriate customer accounts are credited an amount that is equal to the purchase price. In one embodiment, customer accounts are credited an amount that is greater than the purchase price. Conveniently, credits are automatically awarded without the customer having to return to one of the vendor's stores and without requiring the customer to bring the recalled product to the store.

In one embodiment, credits are first placed into a pending credits database and, at a predetermined time, transferred to an in-store credits database. In one embodiment, if a customer would like a cash refund, a refund is provided to the customer (who must travel to one of vendor's stores) and the in-store credits database (or pending credits database, as appropriate) is updated to reflect the refund.

In one embodiment, the notification may also include information regarding the details of the recall, including one or more reasons for the recall. In one embodiment, the notification may include specific instructions relating to the recall including, for example, instructions as to how to or whether to discard the product and/or instructions not to consume the product. In one embodiment, the notification may include information indicating that the amount of credit that is being applied to the customer's in-store credit account.

C. Remote Product Refund

In one embodiment of the present invention, a vendor may provide a remote product refund. That is, if a customer desires to receive a refund on a product, the vendor will credit a customer's in-store credit account with an amount equal to a product's purchase price.

For example, if a customer purchased a product that has gone bad (e.g., milk) prior to a “best if used by” date, the customer can contact the vendor (or a call center under the control of the vendor) to obtain a credit for the purchase price of the product without having to bring the product to one of vendor's stores. Of course, in order for the credit to be applied to the customer's in-store credit account, the customer must have an appropriate customer account.

In one embodiment, the credit is first applied to a pending credits database. In one embodiment, the credit is transferred to an in-store credits database at a predetermined time.

If a customer desires to receive a cash refund, the customer must travel to one of vendor's stores to return the product. In such case, no credits are placed into the in-store credits database for the product being returned.

In one embodiment, credits for any products returned via the call center are placed directly into the customer's in-store credit account (the in-store credit database) and such credits are available for use immediately.

D. Other Automatic Notifications

In one embodiment, the business intelligence engine can be used to notify customers regarding various items of interest to a customer.

For example, since customer purchases associated with customer accounts are tracked and stored, the business intelligence engine may be used to notify customers of an item that is being discontinued. In such case, the customer may decide to relatively quickly purchase a portion of the remaining stock. In one embodiment, the vendor may suggest alternatives to the discontinued product in a notification to the customer. In one embodiment, the customer is notified to look for alternatives.

In one embodiment, based upon the customer's prior purchases, a customer is notified of new items that are being made available by the vendor that fall within the customer's preferred brands or categories.

Several embodiments of the invention have been described. It should be understood that the concepts described in connection with one embodiment of the invention may be combined with the concepts described in connection with another embodiment (or other embodiments) of the invention.

What is claimed is:

1. A method comprising:
entering customer data provided by a customer;
creating a customer portfolio associated with the customer data;
determining whether a piece of media is available;
if a piece of media is not available, then issuing a fulfillment code to the customer, which the customer presents to obtain a piece of media which is associated with the customer portfolio.
